(19) United States
(12) Patent Application Publication
(10) Pub. No.: US 2023/0258306 A1
(43) Pub. Date: Aug. 17, 2023

(54) INTEGRATED LED FIXTURE ASSEMBLY, KIT, AND RETROFIT METHOD

(71) Applicant: KEYSTONE TECHNOLOGIES, LLC, Lansdale, PA (US)

(72) Inventors: Evan Michael Smith, Lansdale, PA (US); Joseph Harclerode, Zieglerville, PA (US)

(21) Appl. No.: 18/159,235

(22) Filed: Jan. 25, 2023

Related U.S. Application Data
(60) Provisional application No. 63/310,644, filed on Feb. 16, 2022.

(51) Int. Cl. F21S 9/02; F21V 23/06; F21V 23/04

(52) U.S. Cl. CPC F21S 9/02; F21V 23/06; F21V 23/04; F21Y 2115/10

(57) ABSTRACT

A light fixture assembly, comprising: (a) a light fixture including a main driver configured to be installed into an opening of a wall or ceiling and to support one or more light-emitting diodes (LEDs) mounted to the light fixture and being in electrical communication with the main driver; (b) a battery for providing a supply of power to the one or more LEDs; (c) an emergency driver in electrical communication with the one or more LEDs and with the battery, the emergency driver being configured to regulate the supply of power from the battery to the light fixture; (d) a conduit having wiring for direct communication between a DC output of the main driver and an output of the emergency driver; and (e) a quick connect assembly for connecting the light fixture to both a main power source and the battery.

### RELATED APPLICATIONS

This application claims priority to U.S. Provisional Patent Application No. 63/310,644, filed on Feb. 16, 2022, all of which is incorporated herein in its entirety for all purposes.

### FIELD

The present teachings generally relate to a light-emitting diode (LED) light fixture assembly, and more particularly, to an LED light fixture assembly having an integrated emergency backup battery and being particularly attractive for use as a retrofit module.

### BACKGROUND

Light fixture assemblies are commonly used in both commercial and residential buildings. These light fixture assemblies may frequently include a light fixture having a recessed can or container secure within a hole of a structure ceiling or wall. The can or container may frequently contain a light bulb, such as an incandescent bulb or a fluorescent bulb. The light fixture assembly is typically wired to a main power source of the structure to power the bulb contained in the can or container.

Recently, light fixture assemblies have been developed that utilize light-emitting diodes (LEDs) for a variety of applications. As a result, conventional light fixture cans or containers having incandescent or fluorescent bulbs are frequently replaced by an LED light fixture. These LED light fixtures may include a housing for the LED to secure the LED in place within a similar hole of a structure ceiling or wall. Similarly, due to the desire to replace conventional incandescent or fluorescent light fixtures, the LED light fixtures may have the ability to retrofit existing light fixtures. That is, the LED light fixtures may typically be adapted to fit into a socket of the respective fixture to be retrofitted. However, it may often be difficult to remove some or all of the existing light fixture to accommodate retrofitting with an LED light fixture due to portions of the existing light fixture being secured to portions of the structure behind the ceiling or wall.

Additionally, commercial buildings are subject to emergency egress lighting requirements. In case of a hazardous condition and/or power outage, light fixtures may require connection to a battery to ensure enough power for lighting the building so that occupants may safely exit the building. Frequently, LED emergency light devices may be added to existing light fixtures. However, these additions may be complex or bulky due to wiring requirements. Furthermore, as discussed above, when retrofitting existing light fixtures, there may be no access within the ceiling or wall to properly wire the emergency backup lighting beyond the existing hole for the light fixture. Thus, space may be very limited.

Moreover, LED light fixtures often have an integrated driver and/or power supply contained within their housing. As a result, the wiring of the LED may not be accessible and thus the LED light fixture may not allow for wiring of an emergency backup battery, regardless of space or access to the fixture. Thus, buildings may frequently require additional holes to be cut into the ceiling and/or wall to secure the secondary backup lights, resulting in excess time and money to meet current requirements.

Examples of lighting fixtures that have been used in the past may include U.S. Pat. Nos. 10,091,855 and 10,683,969; and U.S. Design Pat. No. D824,074, all of which are incorporated by reference herein in their entireties for all purposes. Thus, there remains a need for an LED light fixture assembly that meets current emergency egress lighting requirements. What is also needed is an LED light fixture assembly incorporating an emergency battery to power one or more LEDs, one or more drivers, or a combination thereof in case of a hazardous condition and/or power outage. Additionally, there remains a need for an LED light fixture assembly with an emergency backup which is adapted for retrofit applications of existing light fixtures, and a simple technique for retrofitting such structures. What is particularly needed is an LED light fixture assembly configured for installation through an existing light fixture cutout (e.g., hole) in the ceiling or wall. Similarly, there remains a need for an LED light fixture assembly that provides accessible wiring to electrically connect the LED light fixture assembly to emergency backup devices. For example, there is also a need for an LED light fixture assembly that provides accessible wiring from a main LED driver for connection to a battery, a secondary emergency driver, or both.

### SUMMARY

The present teachings meet one or more of the present needs by providing a light fixture assembly, comprising: (a) a light fixture including a main driver configured to be installed into an opening of a wall or ceiling and to support one or more light-emitting diodes (LEDs) mounted to the light fixture and being in electrical communication with the main driver; (b) a battery for providing a supply of power to the one or more LEDs; (c) an emergency driver in electrical communication with the one or more LEDs and with the battery, the emergency driver being configured to regulate the supply of power from the battery to the light fixture; (d) a conduit having wiring for direct communication between a DC output of the main driver and an output of the emergency driver; and (e) a quick connect assembly for connecting the light fixture to both a main power source and the battery.

The light fixture may include a test button that is capable of illuminating to denote if the light fixture assembly is in an emergency operational mode or a normal operational mode. The light fixture may be powered by the main power source in the normal operational mode. The light fixture may be powered by the battery in the emergency operational mode. The test button may be positioned within the confines of a periphery of the light fixture.

Additionally, the light fixture assembly may include a second conduit having wiring for direct communication between an output of the test button and the output of the emergency driver. The battery and the emergency driver may be housed together in a single housing. The battery and the emergency driver may be housed in separate housings. Moreover, the light fixture may include a trim ring that includes a cutout for the one or more LEDs and an opening for receiving the test button, and optionally may include one or more bend tabs for attaching the ring to a flange of the light fixture.

Furthermore, the quick connect assembly may include a junction box positioned between the light fixture and the emergency driver, and the junction box may include one or more uniquely keyed electrical quick connectors to allow separation, connection, or both for wiring connections between the light fixture and the main power source, the battery, or both. The junction box may also be positioned between the light fixture and the battery.

The light fixture assembly may be configured for both new construction of original equipment and retrofit of an existing construction. The largest dimension (for example, diameter) of the battery and the largest diameter of the emergency driver may be less than about 8 inches (about 20 cm), and may preferably be less than about 6 inches (about 15 cm). Additionally, the main driver may be integrated into the light fixture. Moreover, the light fixture may include adjustable power output for the one or more LEDs, correlated color temperature adjustability for the one or more LEDs, or both. The correlated color temperature selected may be independent of the selected power output.

The present teachings may also meet one or more of the present needs by providing a kit having components for assembling together to form a light fixture assembly comprising: (a) a light fixture including a main driver configured to be installed into an opening of a wall or ceiling and to support one or more light-emitting diodes (LEDs) mounted to the light fixture and being in electrical communication with the main driver; (b) a battery for providing a supply of power to the one or more LEDs; (c) an emergency driver in electrical communication with the one or more LEDs and with the battery, the emergency driver being configured to regulate the supply of power from the battery to the light fixture, wherein a DC output of the main driver is directly connected to an output of the emergency driver by wiring; (d) a plate configured for attachment to a frame of a structure; (e) optionally a trim ring configured for attachment to the light fixture; and (f) optionally a goof ring configured for attachment to the light fixture, the trim ring, or both, wherein the largest diameter of the goof ring is greater than the largest diameter of the trim ring.

The present teachings may meet one or more of the present needs by providing a method of installing the light fixture assembly that may include retrofitting the light fixture assembly into an opening employed for lighting by a pre-existing light fixture assembly, comprising: (a) inserting the battery and the emergency driver through an existing opening in the wall or ceiling prior to or after wiring to the main power source; (b) connecting one or more unique quick connectors of the quick connect assembly to electrically connect the light fixture to the main power source and the emergency driver; (c) inserting the light fixture into the existing opening and securing the light fixture to the wall or the ceiling; and (d) powering the light fixture by the battery upon detection of a power failure by the emergency driver.

The light fixture may be secured to the wall or the ceiling by one or more clips, and preferably the light fixture may be a downlight fixture secured to the ceiling by the one or more clips. The light fixture assembly may be secured to a structural point in the wall or the ceiling prior to installation using a safety clip of the light fixture.

Moreover, the light fixture may be used by: (a) powering the one or more LEDs of the light fixture to illuminate a structure using the main power source; and (b) upon detection of a power outage by the emergency driver, powering the one or more LEDs of the light fixture using the battery to provide emergency lighting within the structure.

Furthermore, the present teachings meet one or more of the present needs by providing: an LED light fixture assembly that meets current emergency egress lighting requirements; an LED light fixture assembly incorporating an emergency battery to power one or more LEDs in case of a hazardous condition and/or power outage; an LED light fixture assembly with an emergency backup which is adapted for retrofit applications of existing light fixtures, and a simple technique for retrofitting such structures; an LED light fixture assembly configured for installation through an existing light fixture cutout (e.g., hole) in the ceiling or wall; an LED light fixture assembly that provides accessible wiring to electrically connect the LED light fixture assembly to emergency backup devices; an LED light fixture assembly that provides accessible wiring from a main LED driver for connection to a battery, a secondary emergency driver, or both; or a combination thereof.

### BRIEF DESCRIPTION OF THE DRAWINGS

FIG. 1 is a perspective view of a light fixture assembly in accordance with the present teachings.

FIG. 2 is a perspective view of a light fixture of a light fixture assembly in accordance with the present teachings.

FIG. 3 is a perspective view of a light fixture and trim ring in accordance with the present teachings.

FIG. 4 is a top-down view of a light fixture assembly in accordance with the present teachings.

FIG. 5 is a close-up view of the quick connect assembly of FIG. 4.

FIG. 6 is a close-up view of an emergency driver and a battery of a light fixture assembly in accordance with the present teachings.

FIG. 7A is a perspective view of a light fixture assembly being inserted into a ceiling hole.

FIG. 7B is a perspective view of the light fixture assembly of FIG. 7A with the clips of the light fixture in a disengaged position.

### DETAILED DESCRIPTION

The explanations and illustrations presented herein are intended to acquaint others skilled in the art with the invention, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference in their entirety for all purposes. Other combinations are also possible as will be gleaned from the following claims, which are also hereby incorporated by reference in their entirety into this written description.

The present teachings generally relate to a lighting fixture assembly. More specifically, the present teachings generally relate to a light fixture assembly that may function to illuminate or light a desired area. The light fixture assembly may include any light fixture secured to or within a structure. The light fixture assembly may be adapted for use in any structure, such as a commercial building, a residential building, an industrial building, a vehicle (e.g., a ship, airplane, automobile, etc.), or a combination thereof. The structure may also be a modular home, an unfinished or otherwise exposed structure (e.g., a construction site), an outdoor structure (e.g., a gazebo), or a combination thereof.

The light fixture assembly may provide lighting using one or more power supplies. The light fixture assembly may include an internal power supply or may be connected to an external power supply. The light fixture assembly may be adapted to light a desired area of a structure during an emergency condition. The emergency condition may be a power outage of a main power supply. The emergency condition may be a natural disaster such as flooding, an earthquake, a tornado, a hurricane, or a combination thereof. Similarly, the emergency condition may be a fire within the structure. As such, it is envisioned that the light fixture assembly may be configured to ensure sufficient lighting of a structure even during an emergency situation to provide occupants safe exit from the structure. Thus, the light fixture assembly may comply with emergency hazard lighting requirements for both commercial and residential structures and may facilitate proper safety of occupants based on the National Fire Protection Association (NFPA) 101®, Life Safety Code®. Similarly, the light fixture assembly may be wired in accordance with NFPA 70®, National Electrical Code (NEC) for US electrical compliance and International Electrotechnical Commission (IEC) 60364.

The light fixture assembly may include a light fixture. The light fixture may function as the lighting fixture of the light fixture assembly. That is, all or a portion of the light fixture may light a desired area of a structure. For example, it is envisioned that the light fixture may be secured to the structure to provide lighting. The light fixture may be secured to any part of the structure, including one or more joists, one or more beams, one or more panels, other structure materials that at least partially form the structure, or a combination thereof. One particular installation may include securing the light fixture within a hole or cutout in the ceiling or a wall of the structure. By way of example, the light fixture may be a downlight fixture secured within a hole of the ceiling. Beneficially, the light fixture may be adapted for installation in various ceiling or wall construction materials. That is, the ceiling or wall may be drywall or gypsum board, may include one or more panels (e.g., a drop ceiling), may be particle board or wood paneling, may be plaster, or a combination thereof. Thus, it may be gleaned from the present teachings that the light fixture may be installed in a variety of structures.

The light fixture may include one or more interconnected components that are assembled during installation. Conversely, the light fixture may be integrally assembled to provide the user a single component to install within the ceiling or wall. For example, the light fixture may include a light and a driver for controlling the light, whereby the driver and the light are secured within the same housing and do not require additional connection by an installer. Thus, installation may be even further expedited.

The light fixture may include one or more lights that function to light a desired area of a structure. While any type of light may be utilized—such as incandescent, fluorescent, halogen, neon, etc.—it is envisioned that the light fixture may be particularly suited to include one or more light-emitting diodes (LEDs). The LEDs may be integrated into the light fixture or may be replaceable within the light fixture (i.e., a replaceable bulb). Illustrative examples of LEDs may include LED bulbs, LED tubes, LED panels, LED modules, or a combination thereof. Similarly, the LEDs may be adapted for lamp holders (e.g., a socket), may include a base of varying size and/or shape (e.g., adapted for various socket sizes, such as a candelabra base, a European base, an intermediate base, a medium-sized base, a large base, etc.), or a combination thereof. Additionally, the LEDs may have varying shapes based upon a given application. The shapes may include various tapers, bends, extensions, other dimensions, or a combination thereof. By way of example, the shapes may also include additional structural characteristics, such as one or more annular bands, one or more grooves or etchings along all or a portion of the LEDs, one or more visual indicators, or a combination thereof.

The LEDs may be adapted for one or more different supply powers and/or electrical circuits. The LEDs may receive power through a circuit having a current of about 2 amps or more, about 6 amps or more, or about 10 amps or more. The LEDs may receive power through a circuit having a current of about 20 amps or less, about 15 amps or less, or about 12 amps or less. For example, the LEDs may be adapted to receive power through a 15-amp electrical circuit or through a 20-amp electrical circuit. However, it is envisioned that the LEDs may be configured to receive power from any desired electrical output.

The light fixture may include a main driver. The main driver may function to control the one or more LEDs of the light fixture. The main driver may function to regulate and/or supply power to the LEDs to illuminate the LEDs. That is, the one or more LEDs may require a substantially constant power supply, and the main driver may provide such a power supply. Similarly, the power may be received by the main driver from an alternating current (AC) power source that is transformed into a direct current (DC) to power the LEDs. Furthermore, the main driver may also facilitate adjustable power to allow for dimming of the one or more LEDs.

To facilitate such control of the LEDs, the main driver may include one or more printed circuit boards (PCBs), one or more controllers, one or more transformers, one or more receivers, one or more transmitters, one or more capacitors, one or more resistors, one or more additional electrical components, or a combination thereof.

The main driver may be secured to the light fixture. The main driver may be integrally formed with all or a portion of the light fixture. That is, the light fixture may be in itself a housing or shell that at least partially encloses one or more components of the light fixture (e.g., wiring, one or more LEDs, etc.), and the main driver me be secured within the housing or shell. Thus, all or a portion of the main driver may be contained within the light fixture. However, it is envisioned that the main driver may still be accessible to an installer with respect to wiring of the main driver.

Additionally, the main driver may include a power switch. The power switch may provide an installer a physical switch to adjust the power received by the one or more LEDs. That is, the main driver may receive an input from the power switch to adjust the power output of the one or more LEDs. The power switch may tune the power supplied to the one or more LEDs by manually selecting one or more options on the power switch. Thus, the one or more LEDs may have an output power of about 2 watts (W) or more, about 5 W or more, or about 12 W or more. The one or more LEDs may have an output power of about 20 W or less, about 17 W or less, or about 14 W or less. However, it is envisioned that the power switch may facilitate various power outputs based upon a given application and electrical circuit.

The power switch may be located anywhere along the light fixture. However, it is envisioned that the power switch may be located near the main driver and positioned along the downlight to be hidden within a ceiling or wall of a structure once installed. Additionally, while manual switching of the power switch has been discussed herein, it should also be noted that such functionality may also be integrated into the main driver wirelessly. That is, a user may wirelessly through a remote or software application (e.g., a mobile application) adjust the power output of the one or more LEDs without physically adjusting a switch on the light fixture.

The main driver may also include a correlated color temperature (CCT) switch. The CCT switch may provide an installer a physical switch to adjust CCT between one or more CCT settings on the switch. That is, the main driver may receive an input from the CCT switch to adjust a color output of the one or more LEDs. The CCT switch may provide one or more selectable CCT settings that correlate to a specific color temperature (e.g., color) output of the one or more LEDs, as measured in Kelvin (K). The one or more LEDs may have a CCT of about 2000K or more, about 2,500K or more, or about 3,000K or more. The one or more LEDs may have a CCT of about 6,500K or less, about 5,000K or less, or about 3,500K or less. Thus, it may be gleaned from the present teachings that the one or more LEDs may be adjustable to a variety of CCT settings based upon one or more designated settings on the CCT switch.

The CCT switch may be located anywhere along the light fixture. For example, the CCT switch may be located near the main driver, near the power switch, or both such that the CCT switch is hidden within the confines of the ceiling or wall once the light fixture is installed. Additionally, the CCT switch may also incorporate one or more integrated wireless features into the main driver. That is, a user may be able to adjust CCT of the one or more LEDs via a mobile device without physically adjusting a switch on the light fixture.

To facilitate installation of the light fixture, one or more clips may be positioned along the light fixture to engage a portion of a wall, the ceiling, or another structural feature to secure the light fixture in place. The one or more clips may be positioned anywhere on an outer casing or surface of the light fixture. However, it is envisioned that the one or more clips may be positioned along the light fixture in a manner to engage the ceiling or wall and secure the light fixture so that a flange of the light fixture abuts the ceiling or wall and covers the hole receiving at least a portion of the light fixture.

The clips may be a single clip or a plurality of clips. The clips may be mechanically movable, bendable, flexible, or a combination thereof. The clips may include one or more biasing members (e.g., a spring or elastic member) that allows for movement of the clips between an installation position (i.e., a position where the clips may be inserted into a hole of the ceiling or wall) and a mounting position (i.e., a position where the clips abut an inner surface of the ceiling or wall to secure the light fixture.

The light fixture may include a trim ring. The trim ring may be secured to the light fixture and have a diameter greater than or equal to a diameter of the flange of the light fixture to provide a finished cover for the flange. As such, the trim ring may be secured to the flange of the light fixture to provide a finished surface for occupants in the structure.

To secure the trim ring, one or more bendable tabs of the trim ring may be bent around the flange of the light fixture. However, the trim ring may include any type of mechanical or adhesive fastener to secure the trim ring to the light fixture. Similarly, the light fixture may include a mechanical or adhesive fastener to secure the trim ring. Alternatively, the trim ring and/or the light fixture may be free of securing means such that the trim ring may rest along a portion of the flange of the light fixture and be secured in place when the light fixture is secured to the wall or ceiling.

Additionally, it is envisioned that the light fixture may include a goof ring. The goof ring may function as a secondary cover to further cover an existing hole in a structure's wall or ceiling. For example, the hole may be oversized beyond an outer diameter of the light fixture as described herein. As such, the goof ring may be secured against or around the trim ring, the flange of the light fixture, or both to hide a visible portion of the oversized hole. Thus, the goof ring may ensure a more finished surface and/or look of the light fixture.

It should also be noted that the trim ring may include a cutout. The cutout may be a portion of the trim ring void of material to allow for unobstructed light from the one or more LEDs to reach a desired area of the structure. The cutout may vary in size and/or shape to accommodate the one or more LED's. Similarly, the trim ring may include one or more tapered portions, one or more recessed portions, one or more projections, or a combination thereof. Additionally, the trim ring may include an opening separate from the cutout to receive a test button of the light fixture.

The test button may function as a status indicator for the light fixture. The test button may facilitate test operations of the light fixture to ensure proper functionality of the light fixture. In particular, it is envisioned that the light fixture may provide emergency illumination for a structure during a power outage or other emergency situation by powering the light fixture via a battery backup. As a result, the test button may provide an installer or tester a means of cycling the light fixture into an emergency power mode (i.e., powering the light fixture via the battery backup). Therefore, an installer or tester may be able to beneficially test the operation of the light fixture during an emergency situation such as a power outage without cutting a main power supply powering the light fixture.

The test button may include one or more lights, such as one or more additional LEDs, to visually indicate whether the light fixture is in normal operation (i.e., being powered by a main power supply) or in emergency operation (i.e., being powered by the battery backup). The test button may also include an audio indication of an operation mode and/or status, such as a beep, chime, or other audible trigger for an installer or tester.

The test button may beneficially be positioned within the confines of the light fixture. That is, the test button may be integrated into the light fixture structure within an outer diameter of the light fixture. For example, the test button may be located along a portion of the flange of the light fixture or a recessed portion of the light fixture adjacent to the one or more LEDs. As a result, the test button may not require a secondary hole in the ceiling or wall for installation, thereby providing a much simpler installation or retrofit.

As discussed above, the test button may be in communication with an emergency system of the light fixture assembly that may power the light fixture during a power outage or other emergency situation that may result in the main power supply unable to supply power to the light fixture. As a result of the emergency system, the light fixture may comply with emergency illumination standards in commercial and/or residential buildings, such as those outlined in NFPA 101® Life Safety Code®. For example, the light fixture may provide illumination for a minimum of 90 minutes under a reduced power mode, such as about 5 W, when being powered by an emergency backup battery. However, it should be noted that various out powers other than 5 W may also comply with emergency illumination standards.

The emergency system of the light fixture assembly may include an emergency driver. The emergency driver may function to control emergency operation of the light fixture. The emergency driver may activate or switch other power supplies of the light fixture when necessary. For example, while the light fixture may be wired to a main power supply of a structure, the emergency driver may detect when the main power supply is experiencing an outage and switch the power supply to a battery of the light fixture assembly instead. Thus, the emergency backup may beneficially ensure consistent powering of the light fixture during an emergency situation.

To facilitate such control of the light fixture, the emergency driver may include one or more printed circuit boards (PCBs), one or more controllers, one or more transformers, one or more receivers, one or more transmitters, one or more capacitors, one or more resistors, one or more sensors, one or more additional electrical components, or a combination thereof.

The emergency system may be in electrical communication with the main driver, the one or more LEDs of the light fixture, the test button, or a combination thereof. With respect to the main driver, the emergency driver may advantageously be wired directly to the main driver of the light fixture free of connection to a main power supply of the light fixture.

For example, the light fixture may include a main power wire and a main driver wire extending from an output of the light fixture. The main power wire may be adapted to connect directly to a main power supply (e.g., a structure's main power line) or may receive passthrough power from the main power supply by connecting to the emergency driver while the emergency driver is in turn connected to the main power supply. Additionally, the main driver wire may be adapted to connect directly to the emergency driver and receive a power supply from a battery connected to the emergency driver. Thus, the light fixture may beneficially be wired for both main power supply during normal operating conditions and a backup power supply (e.g., a battery) during emergency operating conditions. Such wiring may be facilitated by two live (e.g., “hot”) wires—the main power wire and the main driver wire—extending from the light fixture to connect to a main power supply and also allow for direct connection between the main driver and the emergency driver.

While the main power wire and the main driver wire have been discussed in detail above, one or more additional wires may extend from the main driver output to connect to the main power supply, the emergency driver, one or more additional components, or a combination thereof. For example, LED wiring extending from the output of the main driver or light fixture may be adapted to control operation of the one or more LEDs of the downlight. To do so, the LED wiring may include the main power wire and the main driver wire as “hot” wires that supply power to the light fixture. Additionally, the LED wiring may also include one or more additional wires, such as one or more common wires, one or more ground wires, one or more low voltage wires (e.g., providing a voltage of 50 volts or less), or a combination thereof to ensure proper operation of the light fixture. For example, it is envisioned that the one or more low voltage wires may comply with industry electrical standards including, but not limited to, National Electrical Code (NEC) Class 2 Power Circuits and Power Supplies (e.g., NFPA 70, article 725), UL standard 508A, British Standard (BS) 7671, other standards, or a combination thereof. However, it should be noted that the wiring as described herein may comply with various industry requirements according to one or more industry standards to ensure proper installation in various regions and/or applications. Thus, it may be gleaned from the present teachings that various electrical connections may be possible within the light fixture assembly to accommodate various functions, such as power selection of the one or more LEDs, CCT adjustment of the one or more LEDs, additional tuning of the one or more LEDs, or a combination thereof.

Additionally, the connection between the main driver and the emergency drive may provide transformation of the input power received by the light fixture from a power supply. That is, the main driver, the emergency driver, or both may include a transformer that may convert an alternating current (AC) to an acceptable direct current (DC) that may properly power the one or more LEDs of the light fixture. However, while one or more power supplies—such as the main power supply of the structure—may provide an AC current and require a transformer to convert the current to DC, one or more other power supplies may provide an AC current directly to the emergency driver and/or the main driver. That is, transformation of the current may not be necessary. For example, the current from a backup battery may be an AC current that is passed through the emergency driver to the main driver without transformation.

As mentioned above, the emergency driver may also be electrically connected to wiring of the test button. Connection between the test button and the emergency driver may be completed using low voltage wiring (as described above) or may require power above what may constitute low voltage wiring (e.g., about 50 volts or greater). For example, the test button may be powered by 120 volts or 240 volts. However, it is envisioned that low voltage wiring may be sufficient to power the test button. Similarly, the connection may be a 2-wire connection, a 3-wire connection, or a 4-wire connection.

Based on the connection between the test button and the emergency driver, the emergency driver may respond to an installer or tester pressing the test button to initiate a test mode of the light fixture system. That is, when the test button is pressed, the emergency driver may respond by powering the light fixture via a connected battery backup. It should be noted that in such testing conditions, the main power supply may or may not be required to be shut off. Similarly, the emergency driver may send a signal to the test button to indicate a current operating condition of the light fixture (e.g., normal operating conditions via a main power supply versus emergency operating conditions via a battery backup). As such, it may be gleaned that the test button wiring is indirectly in communication with the light fixture via the intermediary emergency driver.

The emergency driver may be connected to a battery. The battery may function as a backup power supply for the light fixture. The battery may be electrically connected to the emergency driver by wiring extending between the emergency driver and the battery. As a result, the emergency driver may dictate when power is supplied from the battery to the light fixture (e.g., during a power outage).

The battery may be electrically connected to the main power supply to be charged or recharged when not in use. However, it is envisioned that the battery may only be connected to the emergency driver so that power coming into the emergency driver from a main power source may be passed to the battery for charging. As a result, the emergency driver may be required to convert an AC current to DC current for input into the battery for charging. Conversely, the output of the battery may be an AC current that is output to the emergency driver when the light fixture is in emergency operating conditions and passed to the light fixture free of transformation.

The battery may be chargeable, replaceable, or both. The battery may be a single battery or a plurality of batteries. The battery may include one or more cells. The battery may be a lithium-ion battery, examples of which are lithium iron phosphate, nickel manganese cobalt, nickel cobalt aluminum, may be cobalt free, may include one or more doping elements (e.g., cations). The battery may be an alkaline battery, a nickel metal hydride (NIMH) battery, or a combination thereof. The battery may power the light fixture at a wattage less than or equal to a wattage provided by the main power supply. However, it is envisioned that the battery may supply power that is less than the power supplied by the main power supply. For example, the battery may have an output power of about 1 W or more, about 5 W or more, or about 10 W or more. The battery may have an output power of about 20 W or less, about 15 W or less, or about 12 W or less.

The battery and the emergency driver may be housed in a single housing or may be housed in separate housings. The housing of the emergency driver, that may or may not include the battery stored therein, may facilitate connection of the emergency driver to the main power supply. Similarly, the emergency driver housing may include one or more outputs such that LED wiring that corresponds to LED wiring extending from the main driver and/or test button wiring that corresponds to test button wiring extending from the light fixture may extend from the emergency driver to connect to the light fixture and/or main driver. The housing containing the battery and the emergency driver may include a removable panel or lid to complete proper wiring within the housing. That is, the housing may function as a junction box between the emergency driver and a main power supply, the emergency driver and the battery, or both.

As discussed above, the LED wiring and the test button wiring may extend from outputs of the light fixture and the emergency driver. Such wiring may be contained within one or more conduits to comply with building codes. The conduit may be rigid or may be flexible. Any desired number of conduits may be used to separate wiring in a desired manner.

The conduits may facilitate wiring extending from the light fixture to connect to wiring extending from the emergency driver within a quick connect assembly. The quick connect assembly may provide an efficient and effective connection means between the light fixture and the emergency driver. The quick connect assembly may include a junction box to contain the connections between the light fixture and the emergency driver. The junction box may include a lid or removable panel to facilitate connection by an installer.

Advantageously, one or more of the wires may include a quick connector to allow for quick connection between wires free of wire nuts or other conventional wire connection means. The quick connectors may also be keyed or unique for each wire or set of wires so that improper connections may not be possible. For example, quick connectors from LED wiring may not be connected to quick connectors from test button wiring, and vice versa. The keying may be a mechanical keying of the connector itself. Similarly, the quick connectors may be color-coded or patterned to easily identify mating wires extending from the light fixture and the emergency driver.

Moreover, as discussed herein, the main power supply may constitute any power supply that powers that light fixture during normal operation. Such a main power supply may be a structure's main power supply (e.g., power coming from a power grid of a city, a main battery with greater power capacity, a generator, etc.). The main power supply may be AC current or may be DC current. The main power supply may supply a power of about 50 volts or more, about 150 volts or more, or about 200 volts or more. The main power supply may supply a power of about 400 volts or less, 300 volts or less, or about 250 volts or less. For example, the main power supply may supply a power of about 108V to about 305V. Thus, it may be gleaned that the main power supply may be any supply of power to maintain normal operation of the light fixture.

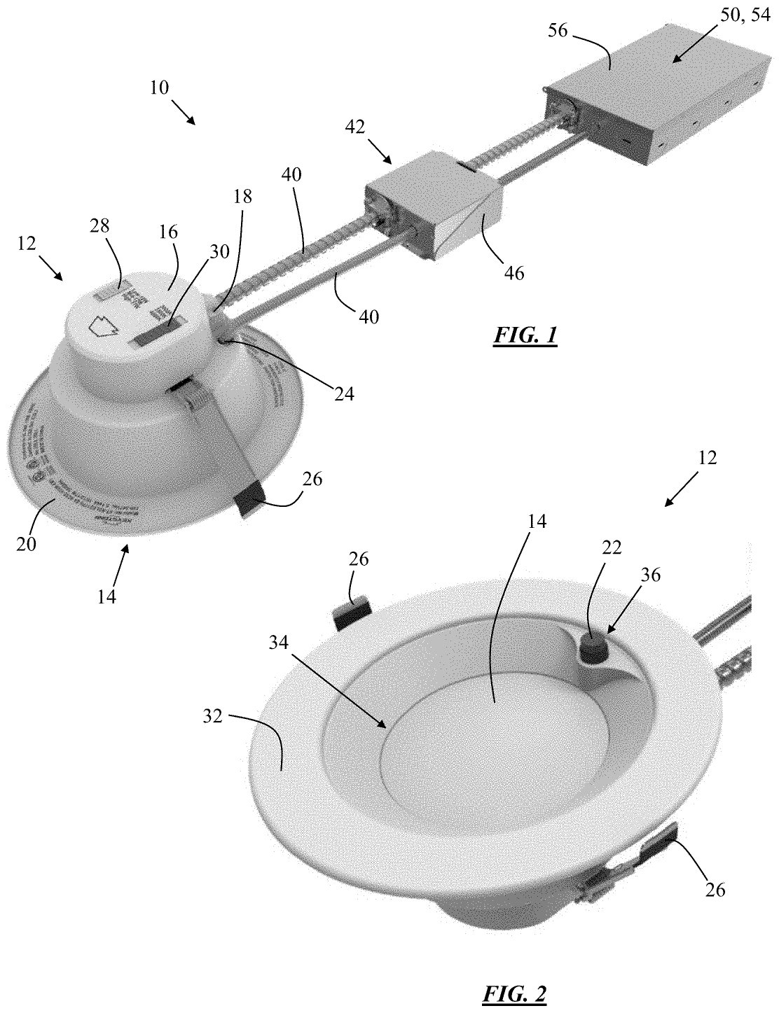

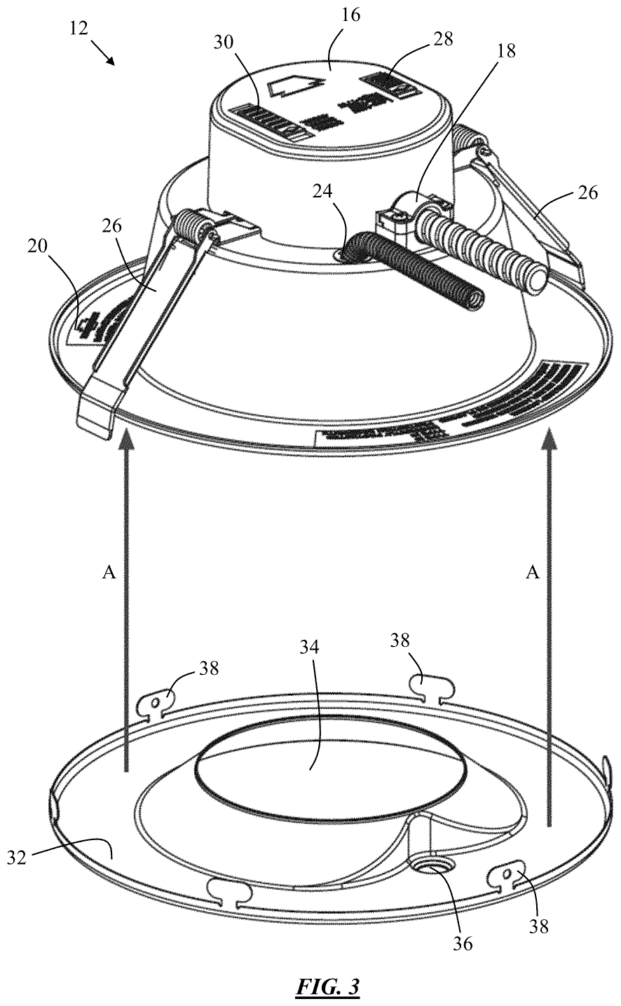

Turning now to the figures, FIG. 1 illustrates a perspective view of a light fixture assembly 10 in accordance with the present teachings. The light fixture assembly 10 includes a light fixture 12 adapted for mounting within a wall or ceiling of a structure by one or more clips 26. That is, the light fixture 12 may be secured within a cutout of the wall or ceiling by the clips 26 such that the remaining portion of the light fixture assembly 10 is hidden behind the wall or ceiling and only a flange 20 or trim ring (see FIGS. 2 and 3) are visible.

The light fixture may include a light-emitting diode (LED) 14 to illuminate a desired area of a structure. The LED 14 may be electrically connected to a main driver 16 that is adapted to control the LED 14 for luminescence. For example, the main driver 16 may include power switch 28, a correlated color temperature (CCT) switch 30, or both to accommodate various configurations of the LED 14 output based on power output (e.g., wattage), color output (e.g., soft white, cool white, daylight, etc.). As such, a user may select a power output via the power switch 28 and/or a CCT level via the CCT switch 30. Based on such inputs, the main driver 16 may control the power supply and color of the LED 14 to meet the selected inputs.

Advantageously, the light fixture 12 may be electrically connected to an emergency driver 50 in case of power outage and/or a hazardous condition that prevents a main power supply from powering the light fixture 12. The emergency driver 50 may be connected to a battery 54 so that, in case of such a power outage and/or hazardous condition, the battery 54 may supply power through the emergency driver 50 to the light fixture 12. It is envisioned that the battery 54 and the emergency driver 50 may be contained within the same housing 56. However, it should be noted that the battery 54 and the emergency driver 50 may also be separate components contained in separate housings or free of any secondary housing.

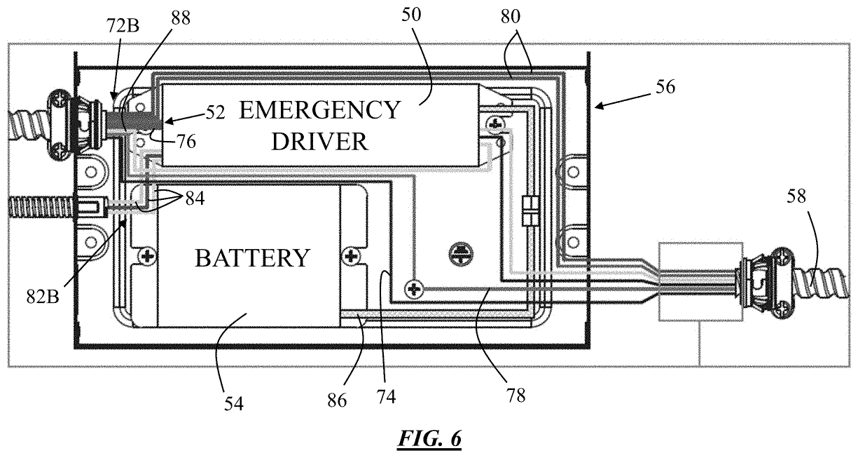

The light fixture 12 may be electrically connected to the emergency driver 50 by wiring extending from an output 18 of the downlight through conduit 40 towards the emergency driver 50. The wiring may extend into an intermediate junction box 46 of a quick connect assembly 42. As a result, the quick connect assembly 42 may beneficially provide easier connection to correlated wiring extending from the emergency driver 50 into the junction box 46. As discussed in further detail below, the wiring extending from the light fixture 12 (e.g., from the main driver 28) and the wiring extending from the emergency driver 50 may include one or more quick connectors that facilitate faster connection of proper wires (see FIGS. 5 and 6).

Additionally, the light fixture 12 may also include separate wiring extending from a test button (see FIG. 2) integrated into the light fixture 12. The wiring may be routed through a second conduit 40 to facilitate proper connection of the test button through the quick connect assembly 42.

Optionally, as shown in FIG. 1, the light fixture assembly 10 may include one or more components in alignment with each other. For example, it is envisioned that prior to and/or after installation of the light fixture assembly 10, the quick connect assembly 42 and the housing 56 containing the emergency driver 50 and the battery 54 may be substantially coaxial or otherwise aligned along a shared longitudinal axis. Additionally, the light fixture 12 may also be in alignment with the quick connect assembly 42 and the housing 56 and share a common axis with the quick connect assembly 42 and the housing 56.

FIG. 2 illustrates a close-up perspective view of the light fixture 12. As discussed above, the light fixture 12 may include one or more clips 26 that secure the light fixture 12 within a cutout or hole of the ceiling or wall so that an LED 14 may be positioned within the hole to illuminate a desired area of a structure. Similarly, a trim ring 32 may be secured to a flange of the light fixture 12 to provide an aesthetically pleasing visible portion of the light fixture 12 while also covering the cutout or hole of the ceiling or wall.

As shown, the light fixture 12 may include a cutout 34 that allows the LED 14 to illuminate a desired area free of obstruction from the light fixture 12. Advantageously, a test button 22 may be positioned adjacent to the cutout 14 and extend through an opening 36 in the trim ring 32 to indicate a current status of the light fixture 12. That is, the test button 22 may illuminate to indicate whether the light fixture 12 is being powered by a main power supply of a backup battery. Similarly, the test button 22 may provide users the ability to test the backup system without physically turning off access to the main power supply.

FIG. 3 illustrates a perspective view of a light fixture 12 and a trim ring 32. As discussed above, the light fixture 12 may include an LED (not shown) connected to a main driver 16 integrated into the light fixture 12. The main driver 16 may control settings of the LED based upon connection to one or more power supplies. Similarly, a user may customize an output of the LED through the main driver 16 by selectable settings on a power switch 28, a correlated color temperature (CCT) switch 30, or both.

The light fixture 12 may be powered by one or more power supplies electrically connected to the main driver 16 through wiring extending from the light fixture output 18. Additionally, the light fixture 12 may also include a test button output 24 for separate wiring connected to a test button of the light fixture 12 (see FIG. 2).

To provide a finished look when installing the light fixture 12, a trim ring 32 may be secured to a flange 20 of the light fixture 12 in the attachment direction (A). The trim ring 32 may include one or more bendable tabs 38 that may be bent to engage the flange of the light fixture 12 and secure the trim ring 32 in place. Additionally, the trim ring 32 may include a cutout to align with the LED and ensure that the trim ring 32 does not obstruct illumination of the LED. Moreover, the trim ring 32 may also include an opening 36 to receive the test button of the light fixture 12.

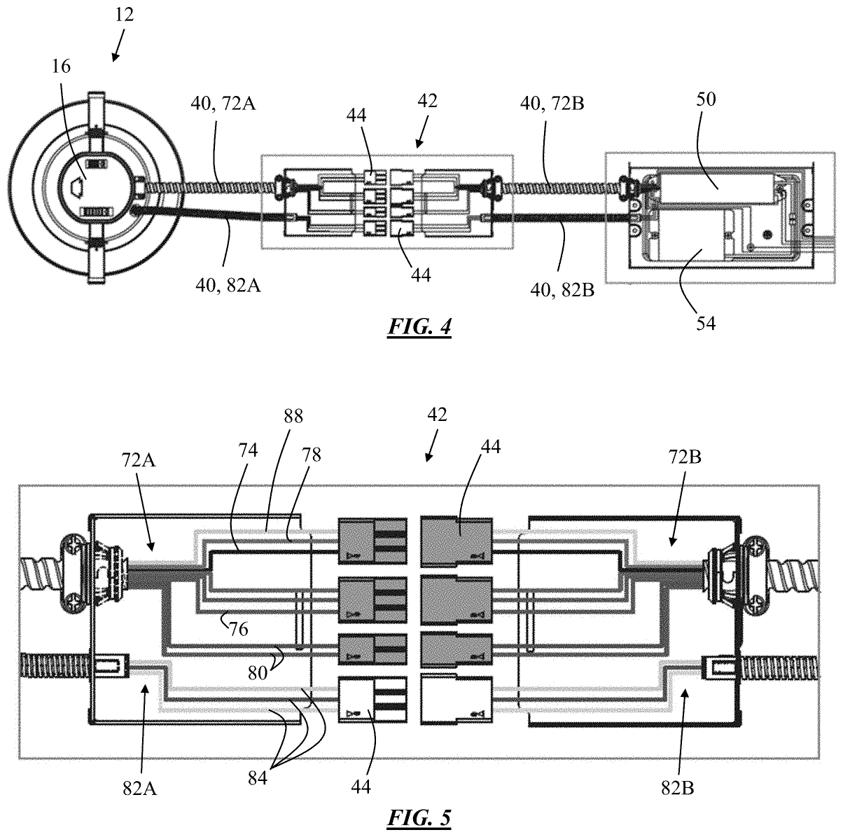

FIG. 4 illustrates a top-down view of a light fixture assembly 10 in accordance with the present teachings. As shown, the light fixture assembly 10 includes a light fixture 12. The light fixture 12 may include one or more of the aforementioned features. For example, it is envisioned that the light fixture 12 may include a main driver 16 to control an LED of the light fixture 12 (see FIGS. 1 and 2).

The light fixture 12 may be in electrical communication with an emergency driver 50 via a quick connect assembly 42. The quick connect assembly 42 may be positioned between the emergency driver 50 and the light fixture 12 so that LED wiring 72A extending from an output of the main driver 16 through conduit 40 may connect to correlated LED wiring 72B extending from an output of the emergency driver 50 through conduit 40. That is, the LED wiring 72A, 72B may each include mating quick connectors 44 to facilitate easy connection between the LED wiring 72A, 72B within the quick connect assembly 42. Similarly, the quick connectors 44 may be keyed or otherwise unique to prevent improper connections between dissimilar wiring. Additionally, it is envisioned that some of the LED wiring 72B may extend from the emergency driver 50 while other LED wiring 72B may extend directly to a main power supply.

Additionally, test button wiring 82A may extend from the light fixture 12 into the quick connect assembly 42 to connect to test button wiring 82A extending from the emergency driver 50 into the quick connect assembly 42. The test button wiring 82A may also include quick connectors 44 to facilitate quick and proper connection between the wires.

FIG. 5 illustrates a close-up view of the quick connect assembly of FIG. 4. As discussed above, LED wiring 72A extending from the main driver of the light fixture may connect to LED wiring 72B extending from the emergency driver by one or more quick connectors 44. As shown, the LED wiring 72A, 72B may advantageously include both a main power wire 74 and a main driver wire 76. The main power wire 74 may be adapted to supply power to the main driver from a main power supply of a structure. The main power wire 74 may communicate through the emergency driver so that, when the main power supply is active and no emergency condition is active, the emergency driver will act as a passthrough to allow power from the main power supply to flow directly to the main driver through the main power wire 74. However, it is also envisioned that the main power wire 74 may bypass the emergency driver altogether and directly connect to the main power supply (see FIG. 6).

Additionally, the main driver wire 76 may provide a secondary connection directly to the main driver without requiring connection through the main power wire 74. That is, the main driver wire 76 may facilitate connection to the emergency driver to allow for powering of the light fixture via the battery in case of an emergency condition (e.g., power outage). As such, the present teachings may provide a light fixture that may provide access to the main driver wiring (e.g., the main driver wire 76) to accommodate secondary power connections in addition to wiring the light fixture to a main power supply. Moreover, the LED wiring 72A, 72B may also include one or more low voltage wires 80, a ground wire 78, and a common wire 88 to ensure proper connection and operation of the light fixture. However, it should be noted that one or more of the above wires may be removed in certain applications when additional wiring is not needed.

Furthermore, as discussed above, test button wiring 82A extending from the light fixture may connect to test button wiring 82B extending from the emergency driver by one or more quick connectors 44. The test button wiring 82A, 82B may include one or more wires separate from the LED wiring 72A, 72B to ensure proper functionality of the test button on the light fixture.

FIG. 6 illustrates a close-up view of an emergency driver 50 and a battery 54 contained in a housing 56 in accordance with the present teachings. As discussed above, the LED wiring 72B may extend from an output 52 of the emergency driver 50 through conduit to the quick connect assembly to connect to the LED wiring from the main driver (See FIG. 5). The LED wiring 72B may include a common wire 88 and a main driver wire 76 that both connect to the emergency driver 50 to facilitate powering of the light fixture in an emergency condition (e.g., a power outage). That is, the main driver wire 76 may advantageously provide a connection between the main driver itself and the emergency driver to control powering of the light fixture by a battery backup 54 connected to the emergency driver 50 by battery wiring 86.

Beneficially, the main driver wire 76 may allow for connection between the emergency driver 50 while still facilitating connection of the main driver to a main power supply 58. As illustrated, a main power wire 74 separate from the main driver wire 76 may connect the main driver directly to the main power supply 58. Similarly, a ground wire 78 may also extend from the main power supply directly to the main driver. It should be noted that direct connection between the main power supply and the main driver may be through the quick connect assembly. As a result, the light fixture and the main driver therein may be connected to both the emergency driver 50 and the main power supply 58, thereby allowing for seamless switching between power supplied from the main power supply 58 and power supplied from the battery 54.

Furthermore, test button wiring 82B may also extend from the emergency driver 50 through conduit to the quick connect assembly to connect to the test button wiring from the test button of the light fixture. The test button wiring 82B may extend from the same output 52 as the LED wiring 72B, or the emergency driver may include a separate output. Similarly, the test button wiring 82B may extend through a separate conduit to the quick connect assembly as shown or may be routed through the same conduit as the LED wiring 72B.

The test button wiring may include a plurality of wires 84 extending from the test button to communicate with the emergency driver. That is, the test button may provide a status indicator (e.g., a light) as to a current condition of the light fixture (e.g., an emergency condition or a normal run condition). Similarly, a user may press the test button on the light fixture to send a signal to the emergency driver to activate the emergency condition. For example, a user may press the test button to test the battery 54 connection without requiring a user to disconnect or turn off the main power supply.

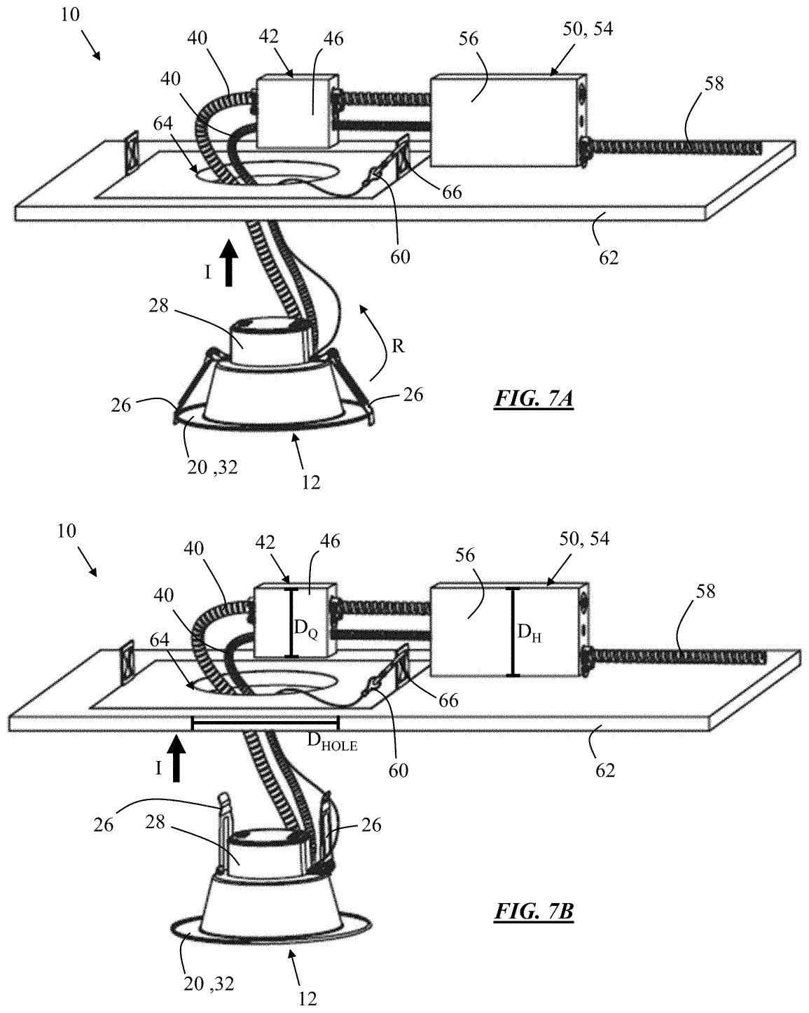

FIGS. 7A and 7B illustrate a perspective view of a light fixture assembly 10 being inserted into a hole 64 in the ceiling 62. It should be noted that a similar mounting may be done in a hole of a wall or any other structure.

The light fixture assembly may include a light fixture 12 electrically connected to an emergency driver 50 and backup battery 54. The light fixture 12 may include wiring extending through one or more conduits 40 into a junction box 46 of a quick connect assembly 52. The wiring from the light fixture 12 may be connected to wiring from the emergency driver 50 or a main power supply 58 extending through a housing 56 containing the emergency driver 50.

During installation, it is envisioned that the emergency driver 50 and/or the housing 56 overall is wired to the main power supply 58 and inserted into the ceiling through the hole 64. Wiring to the main power supply 58 may be completed before or after insertion of the emergency driver 50 into the hole 64. Similarly, before or after wiring to the emergency driver 50 and/or the housing 50 to the main power supply 58, the quick connect assembly 42 may also be inserted into the ceiling through the hole 64. Once inserted, the light fixture 12 may be connected to the emergency driver 50 and the main power supply 58 by connecting the quick connectors within the junction box 46 of the quick connect assembly 42 (see FIG. 5).

As shown in FIG. 7A, once the connectors are connected, clips 26 of the light fixture 12 may be rotated in the direction (R) to facilitate insertion of the main driver 28 and body of the light fixture 12 into the hole 64. Once the clips 26 are rotated, the light fixture 12 is inserted in the direction (I) until a flange 20 of the light fixture 12 and/or a trim ring 32 secured to the light fixture 12 abut an outer, visible surface of the ceiling. As a result, the main driver 28 and body of the light fixture 12 are positioned within the ceiling and not visible. Once the light fixture 12 is properly positioned within the hole 64, the clips 26 may return to their initial position to engage an upper or inner surface of the ceiling 62 to maintain a position of the light fixture 12. It should also be noted that the light fixture 12 may include a clip 60 to secure the light fixture assembly 10 to a fixture 66 within the ceiling 62 during installation.

It is envisioned that installation of the light fixture assembly 10 may be completed as new construction or during a retrofit of an existing light fixture. For new construction, an installer may cut a desired hole 64 in the ceiling or wall and complete the aforementioned steps. Advantageously, installation for a retrofit may also be done in a similar fashion. An existing downlight may be removed so that the existing hole 64 is exposed. Once removal of the old fixture is complete, the housing 56 containing the emergency driver 50 and/or the battery 54 and the quick connect assembly 42 may be inserted through the existing hole 64. To accommodate such connection, the diameter of the housing (D_{H}) and the diameter of the quick connect assembly (D_{Q}) may be less than a diameter of the hole (D_{HOLE}). As a result, an installer is not required to make further cuts into the ceiling 62 and all connections may be done through the existing hole 64.

It should also be noted that retrofit may be completed without removing all of the existing light fixture. That is, all or a portion of the existing light fixture may remain in place and the light fixture assembly 10 may still be installed to retrofit the existing light fixture. By way of example, a can and/or mounting bracketry of an existing light fixture may remain in place when installing the light fixture assembly 10 in accordance with the present teachings. Therefore, it may be gleaned from the present teachings that the light fixture assembly 10 may advantageously provide an easier method of retrofit for existing light fixtures.

Additionally, while it is envisioned that the light fixture assembly 10 as described herein may be installed in any size hole within a structure (e.g., within a wall or ceiling), the light fixture assembly 10 may be particularly useful for retrofitting existing holes for conventional light fixtures. For example, many conventional downlight fixtures may require a 6 inch (about 15 cm) or 8 inch (about 20 cm) diameter, and the light fixture assembly 10 may be adapted for installation through and/or within the 6 inch or 8 inch existing hole.

### ELEMENT LIST

10 Light Fixture Assembly
12 Light Fixture
14 Light-Emitting Diode (LED)
16 Main Driver
18 Light fixture Output
20 Flange
22 Test Button
24 Test Button Output
26 Clip
28 Power Switch
30 Correlated Color Temperature Switch
32 Trim Ring
34 Cutout
36 Opening
38 Tab
40 Conduit
42 Quick Connect Assembly
44 Quick Connector
46 Junction Box
50 Emergency Driver
52 Emergency Driver Output
54 Battery
56 Housing
58 Main Power Supply
60 Clip
62 Ceiling
64 Ceiling Hole
66 Fixture
72 LED Wiring
72A LED Wiring from the Main Driver
72B LED Wiring from the Emergency Driver
74 Main Power Wire
76 Main Driver Wire
78 Ground Wire
80 Low Voltage Wire
82 Test Button Wiring
82A Test Button Wiring from the Light fixture
82B Test Button Wiring from the Emergency Driver
84 Test Button Wire
86 Battery Wiring
88 Common Wire
A Direction of Attachment of the Trim Ring
I Insertion Direction of the Light fixture
R Rotation Direction of the Clip
D_{H} Diameter of the Housing
D_{Q} Diameter of the Quick Connect Assembly
D_{HOLE} Diameter of the Ceiling Hole

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time, and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference in their entireties for all purposes. The term “consisting essentially of” to describe a combination shall include the elements, ingredients, components or steps identified, and such other elements, ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Unless otherwise stated, a teaching with the term “about” or “approximately” in combination with a numerical amount encompasses a teaching of the recited amount, as well as approximations of that recited amount. By way of example, a teaching of “about 100” encompasses a teaching of 100+/−15.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference in their entirety for all purposes. The omission in the following claims of any aspect of subject matter that is disclosed herein is not a disclaimer of such subject matter, nor should it be regarded that the inventors did not consider such subject matter to be part of the disclosed inventive subject matter.

What is claimed is:

1. A light fixture assembly, comprising:
(a) a light fixture including a main driver configured to be installed into an opening of a wall or ceiling and to support one or more light-emitting diodes (LEDs) mounted to the light fixture and being in electrical communication with the main driver;
(b) a battery for providing a supply of power to the one or more LEDs;
(c) an emergency driver in electrical communication with the one or more LEDs and with the battery, the emergency driver being configured to regulate the supply of power from the battery to the light fixture;
(d) a conduit having wiring for direct communication between a DC output of the main driver and an output of the emergency driver; and
(e) a quick connect assembly for connecting the light fixture to both a main power source and the battery.

2. The light fixture assembly of claim 1, wherein the light fixture includes a test button that is capable of illuminating to denote if the light fixture assembly is in an emergency operational mode or a normal operational mode.

3. The light fixture assembly of claim 2, wherein the light fixture is powered by the main power source in the normal operational mode.

4. The light fixture assembly of claim 3, wherein the light fixture is powered by the battery in the emergency operational mode.

5. The light fixture assembly of claim 4, wherein the test button is positioned within the confines of a periphery of the light fixture, and preferably the light fixture and the button are adapted for retrofitting of an existing construction, such as an existing downlight hole.

6. The light fixture assembly of claim 5, wherein the light fixture assembly includes a second conduit having wiring for direct communication between an output of the test button and the output of the emergency driver.

7. The light fixture assembly of claim 6, wherein the battery and the emergency driver are housed together in a single housing.

8. The light fixture assembly of claim 6, wherein the battery and the emergency drive are housed in separate housings.

9. The light fixture assembly of claim 7, wherein the light fixture includes a trim ring that includes a cutout for the one or more LEDs and an opening for receiving the test button, and optionally includes one or more bend tabs for attaching the ring to a flange of the light fixture.

10. The light fixture assembly of claim 9, wherein the quick connect assembly includes a junction box positioned between the light fixture and the emergency driver, and the junction box includes one or more uniquely keyed electrical quick connectors to allow separation, connection, or both for wiring connections between the light fixture and the main power source, the battery, or both.

11. The light fixture assembly of claim 10, wherein the junction box is also positioned between the light fixture and the battery.

12. The light fixture assembly of claim 11, wherein the light fixture assembly is configured for both new construction of original equipment and retrofit of an existing construction.

13. The light fixture assembly of claim 12, wherein the largest dimension (for example, diameter) of the battery and the largest diameter of the emergency driver is less than about 8 inches (about 20 cm), and preferably less than about 6 inches (about 15 cm).

14. The light fixture assembly of claim 13, wherein the main driver is integrated into the light fixture.

15. The light fixture assembly of claim 14, wherein the light fixture includes adjustable power output for the one or more LEDs, correlated color temperature adjustability for the one or more LEDs, or both.

16. The light fixture assembly of claim 15, wherein the correlated color temperature selected is independent of the selected power output.

17. A kit having components for assembling together to form a light fixture assembly according to claim 16, comprising:
(a) a light fixture including a main driver configured to be installed into an opening of a wall or ceiling and to support one or more light-emitting diodes (LEDs) mounted to the light fixture and being in electrical communication with the main driver;
(b) a battery for providing a supply of power to the one or more LEDs;
(c) an emergency driver in electrical communication with the one or more LEDs and with the battery, the emergency driver being configured to regulate the supply of power from the battery to the light fixture, wherein a DC output of the main driver is directly connected to an output of the emergency driver by wiring;
(d) a plate configured for attachment to a frame of a structure;
(e) optionally a trim ring configured for attachment to the light fixture; and
(f) optionally a goof ring configured for attachment to the light fixture, the trim ring, or both, wherein the largest diameter of the goof ring is great than the largest diameter of the trim ring.

18. A method of installing the light fixture assembly of claim 16, including retrofitting the light fixture assembly into an opening employed for lighting by a pre-existing light fixture assembly, comprising:
(a) inserting the battery and the emergency driver through an existing opening in the wall or ceiling prior to or after wiring to the main power source;
(b) connecting one or more unique quick connectors of the quick connect assembly to electrically connect the light fixture to the main power source and the emergency driver;
(c) inserting the light fixture into the existing opening and securing the light fixture to the wall or the ceiling; and
(d) powering the light fixture by the battery upon detection of a power failure by the emergency driver.

19. The method of installation of claim 18, wherein the light fixture is secured to the wall or the ceiling by one or more clips, and preferably the light fixture is a downlight fixture secured to the ceiling by the one or more clips.

20. The method of installation of claim 19, including securing a safety clip of the light fixture to a structural point in the wall or the ceiling prior to step (a).
